(19) United States
(12) Patent Application Publication
(10) Pub. No.: US 2008/0027946 A1
(43) Pub. Date: Jan. 31, 2008

(54) File Management in a Computing Device

(75) Inventor: Richard Fitzgerald, Surrey (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: SYMBIAN SOFTWARE LIMITED, London (GB)

(21) Appl. No.: 11/570,837

(22) PCT Filed: Jun. 22, 2005
(86) PCT No.: PCT/GB05/02462

§ 371 Date: Dec. 18, 2006

(30) Foreign Application Priority Data
Jun. 24, 2004 (GB) 0414175.0

(51) Int. Cl. G06F 17/30

(52) U.S. Cl. 707/10; 707/E17.032

(57) ABSTRACT

When reading a directory on a computing device, the file server adds unique tags to the listing when passing the listing to a client application. The file server keeps a list of the unique tags together with the physical addresses of the files to which they correspond. When a client wishes to open a file, it can do so by passing the tag to the file server. This enables the file server to load the file directly without having to undertake a second directory search to discover the physical location of the file from its filename.

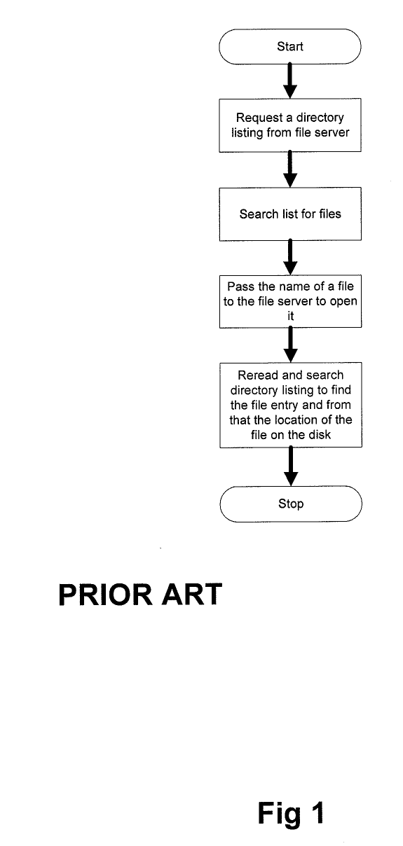

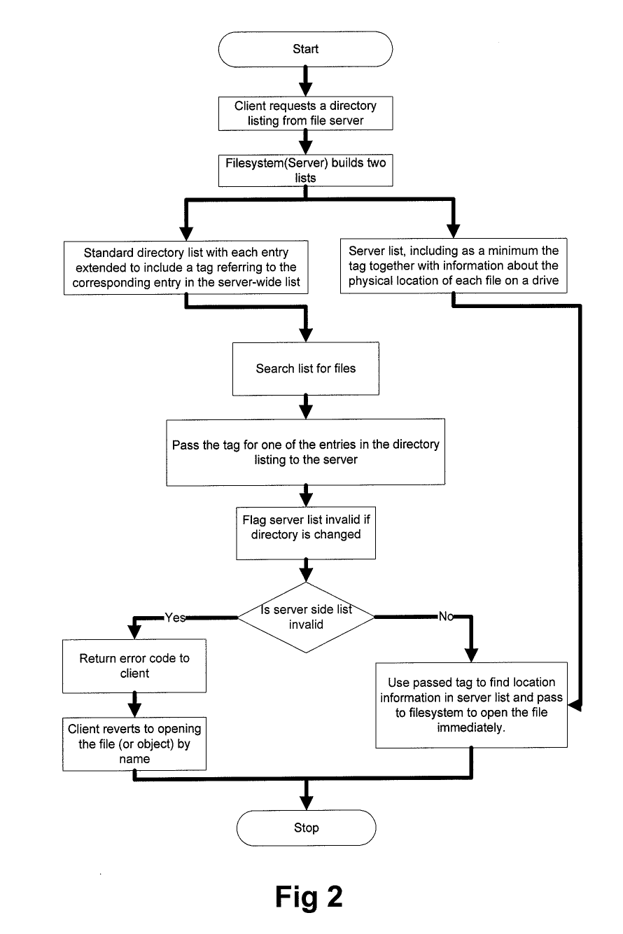

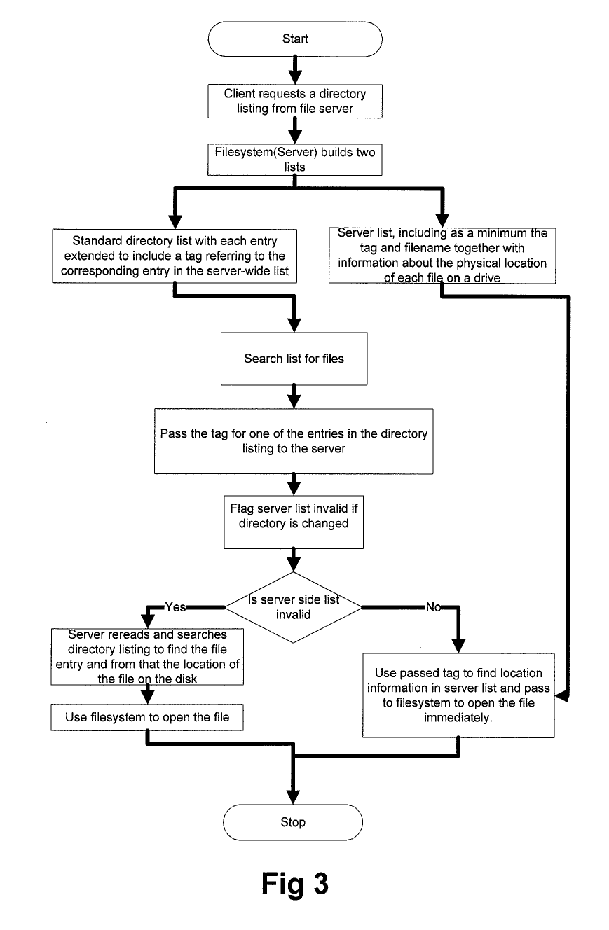

The present invention relates to file management in a computing device, and in particular to an improved method of opening files in a computing device.

The term computing device as used herein is to be expansively construed to cover any form of electrical computing device and includes, data recording devices, computers of any type or form, including hand held and personal computers, and communication devices of any form factor, including mobile phones, smart phones, communicators which combine communications, image recording and/or playback, and computing functionality within a single device, and other forms of wireless and wired information devices.

Files on computing devices are persistent named data stores, presented as a single stream of bits. File management is one of the major tasks of operating systems for all but the simplest computing devices. In the early days of stand-alone personal computers, file management was arguably the main operating system task, as is shown by Microsoft's choice of the acronym DOS (Disk Operating System) for their first OS (Operating System). While user interfaces have become more complex, and the growth of networked and connected systems and the convergence of computing and telecommunications devices has increased the importance of network and link management, file management still remains one of the functions at the core of any advanced computing device.

The most basic file management tasks in modern operating systems are
keeping a directory or index of files on the system
opening or creating named files on request
enabling content to be read and written.
enabling deletion of files or content

### The part of the operating system which looks after file management is called the filesystem.

Although the filesystem is an essential part of the OS, it is frequently one of the most significant bottlenecks in the system and multiple filesystem accesses will therefore reduce the effective speed of operation of any computing device. There are two main reasons for this:
Because of the complexity of the work that needs to be done by the filesystem, writing and retrieving data files can be computationally quite expensive. Most filesystems make use of multiple levels of indirection, both in order to abstract away specific hardware characteristics and inefficiencies, and also in order to impose logical structure on the various types of data that need to be stored. Additionally, all filesystems that are not read-only (RO) have to dynamically cope with changes to the content of the data that they manage; they have to ensure that the integrity of data already on the system is not compromised when writes occur, and they also have to anticipate and handle error conditions such as ‘disk full’ and ‘bad block’.
More significantly, the physical media on which persistent files are stored (which is generally referred to a disk or a drive for historical reasons irrespective of whether it is a disk drive or not) almost always has slower access speeds than the other hardware comprising the computing device. This is most apparent in the traditional floppy and hard disk drives used on personal computers, which rely on relatively slow magnetic storage on metallic compounds. The basic floppy disk data transfer rate is only 150 kilobits/sec. Whilst hard disks are much faster and now approach speeds of 100 megabits/sec, this is still much slower than the speed of the random access memory (RAM) in the device, which can now be in excess of 1.5 gigabits/sec. As well as their relatively slow raw data transfer rates, disk drives are also adversely affected by the need to physically rotate the media; a characteristic which they share with more modern CD and DVD drives, which rely on laser technology and read data and are typically able to write data at speeds of up to 10 × that of floppy disks, and read data at around 50× that of floppy disks. The problem with all rotational media is that they have a relatively high latency; they cannot provide data instantly, because the disk has to be rotated to the correct position before it can be read, and the need to wait for the drive to get ready to read introduces even longer delays.

These considerations have been growing in importance over the last few years because of their applicability to battery operated mobile computing devices such as mobile telephones, Personal Digital Assistant (PDAs), and digital cameras. While this class of devices does not generally use rotational media for persistent storage (though some MP3 players such as the Apple iPod are an exception), they do commonly use solid-state media such as flash memory disks, CF (Compact Flash) cards, MMC cards (MultiMedia Cards), Memory Sticks, SM (Smart Media) cards and SD (Secure Digital) cards.
Although these solid state media do not suffer from the same latency problems as rotational drives, their data transfer rates are still much slower than RAM (typically 1 megabit/sec to 2 megabits/sec) so the incentives described above to reduce disk access in order to improve overall device performance apply equally.
Additionally, it is well known that the speed of access to read-only memory (ROM) is much slower than that of random access memory (RAM); this is one reason why most personal computers copy the contents of ROM into RAM and remap memory accesses to the fast RAM instead of to the slow ROM to improve performance. Users of battery operated mobile devices which boot from ROM, such as cellular phones, PDAs and digital cameras would derive much benefit from a faster boot time, because the delay between power-on and the device becoming operational is often found frustrating to users of these devices. Anything that speeds up a ROM filesystem would decrease boot time, and is therefore highly desirable and of considerable benefit for this class of devices.
Of equal significance is the fact that access to solid-state storage devices leads to a battery operated device consuming power at a higher rate, and this clearly results in a shorter useful life between battery recharge or replacement. Therefore, any technique that minimises access to a filesystem helps to conserve power, and results in increased device utility.

Computer system designers and software architects have for many years sought ways of minimising accesses to both the filesystem and to the physical disk in order to speed up the operation of the computing device as a whole. Most of the speed improvements rely upon the use of caching techniques.

For example, when part of a block of data needs to be read from a slower medium such as a disk, the entire block can be read and temporarily stored on a faster medium such as RAM in a read cache; this means subsequent reading of data from the same block does not need to access the slower storage medium because the data is already present in the cache (being able to read data from the cache in this way is known as a cache hit). A write cache (also known as a lazy write) works slightly differently, by eliminating multiple inefficient write operations; small amounts of data to be written to the disk in memory are kept in the cache until sufficient data has accumulated to make a physical write worthwhile.

A slightly less well-known caching mechanism which is of particular interest to the field of this invention is a name cache which has been designed to cater for a specific bottleneck in the filesystem.

The background to the working of a name cache is that filesystems generally store pointers to the physical location of files and directories together with their names in a logically hierarchical structure. In such a structure, a single root directory is always the initial place where file retrieval begins; the root (or top level) directory contains a number of directory entries which can either point directly to files, or alternatively can point to one or more second level directories. These second level directories may themselves either point directly to files, or may point to third level directories. This directory nesting can continue to many levels in depth.

The bottleneck with which a name cache is designed to cope arises from the method used to physically locating a file on a disk starting from its unique pathname—a pathname consists of the file name, prefixed by the subdirectory in which the file is found, which is in turn prefixed by the directory in which that subdirectory is found; and so on back to the root directory.

Given a pathname, in order to physically locate the file, the filesystem has to
1) parse the string representing the filename into its separate directory and file components;
2) find the root directory on the disk;
3) iterate a read of each directory entry until a match is found for the name of the next level directory;
4) retrieve the attributes of the next level directory, including its physical location, and find it on disk;
5) repeat steps 3 and 4 for each directory in the path until the lowest level directory is reached
6) iterate a read of each entry in the lowest level directory until a match is found for the name of the file;
7) retrieve the file attributes, including the physical location of the file.

The large number of iterations of string comparisons, filesystem seeks and filesystem reads can be reduced by the use of a name cache. This stores the physical locations of recently accessed files and directories along with their names.

DNLC (Directory/Dynamic Name Lookup Cache) is a common implementation of such a name cache used on the Unix/Linux family of operating system (collectively referred to as *nix). Attempts to open a file on a system with a DNLC first look up the fully qualified pathname in the cache via a hash algorithm, and retrieve the physical location of the file directly from the cached entry on a cache hit; if the filename is not in the cache, the directories are looked up in the cache (from the innermost outwards) and if there is a cache hit on one of the directories, its physical location can be obtained from the cache and the search can be taken up from that point on the disk. Provided at least some of the pathname is in the cache, this method can be effective at reducing disk accesses for frequently accessed files.

All current operating systems regard requests for directory listings and requests to open files as distinct and separate operations.

This invention is predicated on the basis that it is very seldom the case that requests for directory listings are made in isolation; the vast majority of directory listings are requested in anticipation of open one of the files returned in that listing. The most common use case for directory searches in computing devices is where the request is followed by the application scanning through the directory and selecting one or more files in that directory to be opened.

Typical examples can be found in many operating systems, especially during the bootup process. In Microsoft Windows for instance, many files are loaded from system directories such as \windows\system32, while frequently accessed Unix and Linux system directories include /etc /bin and /lib. Symbian OS™, the advanced operating system for mobile phones from Symbian Software Ltd., accesses directories such as \sys and \resource both when booting and when loading executable and resource files.

The usual method of performing this task is to start by requesting a directory listing from a file server, which is the component responsible for providing filesystem access to multiple client applications and processes. The directory listing is generated by finding the directory information on the disk and then walking through every entry to build the list returned to the client. The client then searches the list for files and passes the name of a file to the file server to open it—at this point the directory is reread and searched again to find the file entry and from that the location of the file on the disk.

The clear disadvantage of this process is that a failure to recognise the linkage between a directory search and the subsequent opening of the file has required a completely unnecessary second search of the directory. All the information about the location of the files was available when the directory list was initially built but it was ignored. Thus time, and therefore battery power, is wasted searching through the directory again for this information at the time when the file was actually opened.

One or more directory listings can be kept in a read cache, in which case it is undoubtedly faster to search through the cached copy in memory than to go back to the physical disk. Furthermore, if a file or directory is opened frequently, then it is possible that its physical location might be kept in the name cache.

But, neither of these methods solves the basic problem of useful information (the directory listing) having to be accessed, read and searched twice because the first access was discarded. Even if the read cache does contain a copy of the directory, this only avoids the need for reading the directory from disk. The read cache will still have to be searched twice; and a name cache is not going to be of any use for a file that has not yet been opened.

It is therefore an object of the present invention to provide an improved method for the management of files in a computing device.

According to a first aspect of the present invention there is provided a method of file management in a computing device incorporating a directory structure, the method comprising
a. arranging a directory listing of a filesystem to include a uniquely identifiable tag for each entry in the directory;
b. when providing the directory listing to a client, retaining a copy of the listing comprising a tag for each entry in the listing indicative of the physical location of an object referred to by that entry;
c. accepting a request to open an object by reference to its tag; and
d. retrieving the physical location of the said object, and opening the object at its physical location.

According to a second aspect of the present invention there is provided a computing device arranged to operate in accordance with a method of the first aspect.

According to a third aspect of the present invention there is provided an operating system for a computing device for causing the device to operate in accordance with a method of the first aspect.

An embodiment of the present invention will now be described, by way of further example only.

With the present invention, when a client requests a directory listing, the file system builds two lists; one is returned to the client, whilst the other is held by the server. The list returned to the client is a standard directory list with each entry extended to include a tag referring to the corresponding entry in the server-side list. The list held by the server includes (as a minimum) the tag; together with information about the physical location of each file on a drive (this is the information that is needed to open the file). Note that because each entry returned to the client is tagged, the client can freely sort its own list without breaking the link between that list and the server-side list.

Preferably, the server list is held in an array with the tag of each item in the list also acting as its index to the array.

When a client wants to open a file, a new open file method is provided by the file server. Instead of being passed a filename or a pathname as a parameter, this new method takes as a parameter the tag for one of the entries in the directory listing.

The file server then uses this tag to find the location information in its array and passes this to the file system. The file can then be opened immediately without having to search the directory again.

This method is clearly advantageous over a system which simply caches directory listings, in which files still have to be opened by name even when a cache hit occurs, incurring the extra search overhead. The multiple string comparisons that this entails, especially on modern systems which use Unicode filenames, are non trivial.

On read-only filesystems (such those for ROM and ROFS disks) the steps already described are sufficient, because the contents of the disks never change. There will therefore be a performance improvement for all cases where files are loaded after searching a directory listing; the filesystem innovations of this invention will always allow files to be opened directly by tag with no searches involved.

In order to extend this innovation to writeable drives, a mechanism to handle changes to a directory list may be included. Such changes can comprise, for example, changes to the length of existing files, file deletion, or the creation of new files.

A number of possible mechanisms for achieving this will now be described.

The most straightforward mechanism is to flag the entire server-side list as being invalid if the directory is changed. In this case, attempts to open a file (or any object) referred to by any entry by means of passing its tag then causes the file server to return an error code to the client, which then reverts to opening the file (or object) by name.

A modified implementation of the above mechanism requires the server-side list to additionally store the filename, as well as the tag and the physical location of the file. In this case, passing a tag to a file on an invalidated list causes the file server, rather than the client as in the above example, to revert to opening the file or object by name, transparently to the client.

An alternative mechanism which avoids the necessity for the storage of the filename in the server-side list is for an additional version of the file open method to be provided which takes both a tag and a filename as parameters. This mechanism may be used with writable filesystems and enables the transparent fallback to opening the file by name by the server described above without the necessity for the storage of filenames in the server-side list.

The fact that there is no need to keep filenames in the server-side list in this implementation is particularly advantageous as far as memory utilisation is concerned. Storage of all names (especially long Unicode names) can be particularly burdensome on memory; as a result, many *nix implementations of DNLC name caches have found it necessary to limit the size of cached names to around 15 characters, which seriously affects the utility of the name caching scheme. Battery operated mobile computing devices in particular are resource constrained, so a method enabling the server list to simply store tags and physical locations even for writable drives is considered highly desirable and beneficial.

Optionally, with either of the two latter mechanisms, the server-side list may be updated automatically at the same time as the reversion to name specified file tag opening by the server.

A set of more complex mechanisms may also be developed by enabling the file server to actively monitor activity that could potentially cause changes to a directory and to dynamically adjust the contents of its list to ensure that it was always valid. For example, the server may be arranged to check whether there is an open file listing on a directory before making a change and either invalidate a single entry in the server side array, or ideally update it with new information.

Where a single entry is invalidated, either an error code may be returned to the client, or if the server list included file names as described above, the server could automatically fall back on opening the file by name; optionally, the server-side list entry could be updated and revalidated at the same time.

The application of the invention to ROM/ROFS drives is most significant, as it directly improves device boot time. The simplicity of this form of the invention means that there is no significant run-time overhead beyond the initial generation and storage of the server-side list; and because this overhead involves internal memory on the computing device rather than slow external media, the initial overhead would almost certainly be recouped the first time a new call to open a file by tag is used.

One particular advantage of this invention is that it can be included in most filesystem application programme interfaces (APIs) without breaking compatibility with previous client APIs. The only changes needed will usually be one or more file Open( ) functions which take tags as parameters either in addition to or instead of filenames. However, it is acknowledged that some systems may require modification to use this invention but a method that encapsulates a directory search and a file open as a single operation would in most cases benefit in terms of speed of operation and power consumption were it to be adapted to make use of the invention.

There are a number of ways of deciding how many directory lists the file server should keep, examples of which will now be outlined:
A single server-side list may be provided for all file sessions on each logical drive; this is beneficial in situations where a single client is loading up files in a single file session, or where a single directory is being used by all file sessions. However, such situations are in practice likely to occur relatively infrequently, because file servers are used to allow multiple clients to access files without locking each other out.
One server-side list per file session may be provided. This potentially uses more memory than the single server-side list, but is still beneficial when multiple sessions are opened with the file server.
Multiple server-side lists per file session may also be provided; this may be implemented either via a hardwired number, or by introducing additional methods giving some minimum number of lists to all file sessions but also allowing them to request extra lists up to either a fixed maximum or a dynamic maximum which depends on factors like memory usage and system loading. Note that in this case, where a session could have multiple lists, the server needs to ensure that all the tags used are unique across all lists.
A precompiled list of commonly used system directories in the boot ROM may be used which enables a large number of operations to proceed without any directory searches, and is considered to be especially beneficial in terms of faster boot time.

Which of these options is best in any particular circumstance may be determined by profiling a device to discover common usage patterns. Those skilled in this art will both know how to achieve such profiling and will also appreciate that the necessary trade-off in memory usage against speed are dependent on circumstances and cannot be legislated rigidly in advance.

Thus, with the present invention, when reading a directory on a computing device, the file server adds unique tags to the listing when passing the listing to a client application. The file server keeps a list of the unique tags together with the physical addresses of the files to which they correspond. When a client wishes to open a file, it can do so by passing the tag to the file server. This enables the file server to load the file directly without having to undertake a second directory search to discover the physical location of the file from its filename.

The present invention is considered to provide several significant advantages over known file management systems, including
avoiding double searching of directories on disk by saving the position information of a file when building the directory list; this means clients can open files immediately from this information without having to search the directory again
quicker searching for files to open; the code is shorter and fewer accesses are required to slower persistent storage. This is of particular benefit when searches of the same directory are followed by file loads
because fewer accesses are required to less power-efficient persistent storage as well as fewer CPU cycles, improved battery life on mobile computing devices can be achieved, providing benefits in terms of user satisfaction and the environment
when applied to read-only filesystems used to boot up devices it results in a shorter time between device switch on and the device becoming operational. This directly improves user experience and utility, especially of portable battery operated devices such as mobile phones, PDAs and digital cameras, which are often switched off to save power but for which quick access to full functionality is considered extremely useful and important
optimised speed and power consumption by eliminating unwanted disk accesses and directory searches. In this respect it is superior to caching methods, which can reduce disk accesses but do not eliminate any directory searches
in comparison to caching the entire directory, the server-side list makes far fewer demands on memory than does a cache. It consists, as a minimum, of a tag and a physical disk address. Furthermore, in the preferred implementation where the tag can be used as an index to the server-side list held as an array, the retrieval of the physical location of a file is extremely fast; unlike a cache, there is no searching necessary
in comparison to caching techniques in general, far lower management overhead is achieved; maintaining and searching a cache is a non-trivial exercise and there is the additional burden whenever there is a cache miss
for most operating systems, this invention may be implemented extremely quickly and with very few changes to existing APIs and data structures. There is consequently a high probability that there will be no compatibility breaks with existing software
the method is highly generic and can be implemented in the prevailing idioms and patterns used by a variety of operating system APIs and in a wide variety of programming languages
because previous methods of opening files work unchanged, there is no need for any existing software applications to change
because the new file open methods are simple, very little effort is required by application developers deciding to use the invention.

Although the present invention has been described with reference to particular embodiments, it will be appreciated that modifications may be effected whilst remaining within the scope of the present invention as defined by the appended claims.

1. A method of file management in a computing device incorporating a directory structure, the method comprising
a. arranging a directory listing of a filesystem to include a uniquely identifiable tag for each entry in the directory;
b. when providing the directory listing to a client, retaining a copy of the listing comprising a tag for each entry in the listing indicative of the physical location of an object referred to by that entry;
c. accepting a request to open an object by reference to its tag; and
d. retrieving the physical location of the said object, and opening the object at its physical location.

2. A method according to claim 1 wherein the filesystem is controlled by a file server for providing filesystem services to multiple clients arranged to maintain one or more distinct sessions with the file server.

3. A method according to claim 1 wherein the objects are selected to comprise files or other directories or any other entities.

4. A method according to claim 1 wherein the tags are maintained in a listing in the form of an array in which the tags act as an index for enabling the physical location of respective objects to be retrieved.

5. A method according to claim 1 wherein the filesystem comprises a read-only filesystem.

6. A method according to claim 5 wherein the read-only filesystem is used to boot the computing device.

7. A method according to claim 1 wherein the filesystem comprises a writable filesystem.

8. A method according to claim 7 wherein the retained listing is invalidated if any change is made to the directory from which it was originally derived; and, passing an error code back to a client requesting to open an object having a tag in an invalidated listing for causing the client to open the object by name.

9. A method according to claim 7 wherein the retained copy of the listing further comprises respective names for objects; the retained list is invalidated if any change is made to the directory from which it is was originally derived; and a request to open an object in an invalidated list causes the object to be opened using the respective name in the retained list.

10. A method according to claim 7 wherein the filesystem is arranged to accept a request for opening an object referred by tag and by object name; the retained listing of tags is invalidated if any change is made to the directory from which it is was originally derived; and a request to open an object by a tag in an invalidated listing causes the filesystem to open the object using the object name.

11. A method according to claim 8 wherein the filesystem is arranged to update and revalidate its retained listing after an invalidated listing has caused an object to be opened by name.

12. A method according to claim 8 in which the filesystem is arranged to monitor activity for causing changes to entries in a directory for which it has a retained directory listing, and in which a tag is invalidated whenever affected by a change instead of invalidating the retained listing, and objects are opened by name only when a request is made using an invalidated tag; or the filesystem is arranged to dynamically update entries which would otherwise have been invalidated.

13. A method according to claim 1 wherein either
a. a single retained directory list is allowed for each logical drive on a system; or
b. a fixed number of retained directory lists is allowed per file server session; or
c. multiple retained directory lists are allowed per file server session by client request, up to a fixed or dynamic maximum.

14. A method according to claim 5 in which read-only filesystem usage is profiled and one or more retained directory listings are predefined and included in a boot ROM for automatic use during the boot process or any other predicable and profitable sequence of operations for the computing device.

15. A computing device arranged to operate in accordance with a method as defined in claim 1.

16. An operating system for a computing device for causing the computing device to operate in accordance with a method as defined in claim 1.
